(19) United States
(12) Patent Application Publication
(10) Pub. No.: US 2017/0373457 A1
(43) Pub. Date: Dec. 28, 2017

(54) WAVEGUIDE FOR DIODE-PUMPED ALKALI LASERS

(71) Applicant: Lawrence Livermore National Security, LLC, Livermore, CA (US)

(72) Inventors: Mark D. Rotter, San Ramon, CA (US); Raymond J. Beach, Livermore, CA (US); Robert C. Bickel, Walnut Creek, CA (US)

(73) Assignee: Lawrence Livermore National Security, LLC, Livermore, CA (US)

(21) Appl. No.: 15/629,545

(22) Filed: Jun. 21, 2017

Related U.S. Application Data
(60) Provisional application No. 62/353,759, filed on Jun. 23, 2016.

(51) Int. Cl. H01S 3/04; H01S 3/063; H01S 3/041; H01S 3/227; H01S 3/0941

(52) U.S. Cl. CPC H01S 3/0407; H01S 3/227; H01S 3/0941; H01S 3/0401; H01S 3/041; H01S 3/063

(57) ABSTRACT

An improved architecture for optical waveguides as used in a diode-pumped alkali laser system is provided by using micro-channel-etched silicon or other metal in place of the more usual sapphire.

### CROSS-REFERENCE TO RELATED APPLICATIONS

This application claims the benefit of U.S. Provisional Patent Application No. 62/353,759 titled “Waveguide for Diode-Pumped Alkali Lasers,” filed Jun. 23, 2016, incorporated herein by reference.

### STATEMENT REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

### Field of the Invention

The present invention relates to techniques for cooling waveguides, and more specifically, it relates to improved means for cooling diode pumped alkali lasers.

### Description of Related Art

The current architecture for the majority of diode-pumped alkali laser (DPAL) designs is the end-pumped configuration, where the pump light enters from one end of the gain region. In such a geometry, the pump light must be ducted down the gain region in order to efficiently pump the alkali-vapor gain medium.

Current waveguide designs call for a multi-layer dielectric stack deposited on a sapphire substrate. The dielectric stack provides high reflectance for the pump radiation at 780 nm (over a specified angular range). It also provides sufficiently low reflectance for the laser radiation at 795 nm so as to prevent parasitic oscillations from forming. The lower reflectance at 795 nm also allows the transmission of spontaneous emission (fluorescence) through the waveguide.

Thermal management for the waveguide is provided by means of metallic heat exchangers placed in close proximity to the waveguides. The fluorescence is incident on the face facing the waveguide and is absorbed. The heat so generated is removed by means of cooling fluid that circulates via channels machined into the heat exchanger.

A schematic drawing showing the relationship between the right sapphire mounted waveguide 10 and the heat exchanger 12 is shown in FIG. 1. In the drawing, the helium filled gap 14 between the waveguide 10 and the heat exchanger 12 is greatly exaggerated. Although not shown in the figure, a similar arrangement exists for the left waveguide 16. The pressure vessel 18 intercepts any fluorescence escaping out the top and bottom waveguides.

In general, the thermal resistance between where the energy is deposited and the location of the cooling fluid is quite large—in the range of 2.6 to 7.6° C./W/cm². Typical operation of the laser can result in fluorescence loads approaching 50 W/cm², with the result that the heat exchanger can experience a temperature increase of 130-380° C. Because the heat exchanger is separated from the waveguide by a thin gap of stagnant gas, the waveguide also increases in temperature by this same amount.

The large increase in waveguide temperature is deleterious for several reasons. At operating temperatures approaching 500° C., the dielectric stack can dramatically change its reflection characteristics which can lead to catastrophic failure. The temperature difference between the flowing gas in the gain cell and the waveguide leads to very poor beam quality due to large temperature gradients near the waveguide walls.

The use of micro-channels to cool laser diodes and laser diode arrays is beneficial in efficiently removing heat from a laser diode bar, where the thermal flux can be on the order of 1000 W/cm². Typical thermal impedances for the micro-channel design can approach 0.0125° C./W/cm², which is a 200 to 600× improvement over the waveguide cooler design of FIG. 1.

A scanning-electron-microscope image of micro-channels as etched into silicon is shown in FIG. 2. As can be seen, the typical channel width is on the order of 40 μm. This is extremely large by modern photo-lithographic standards and can easily be manufactured. The cooling fluid is delivered to the micro-channels by means of a plenum bonded to the silicon. Using, for example, borosilicate glass, the Si may be anodically bonded to the plenum.

### SUMMARY OF THE INVENTION

We present an improved architecture for optical waveguides as used in a diode-pumped alkali laser system. The improvement comes from using micro-channel-etched silicon or other metal in place of the more usual sapphire. This geometry allows for much more efficient heat removal, leading to more robust, lighter laser designs.

Past and current uses of micro-channel technology are primarily in the area of laser diode cooling. The architecture described herein can potentially be used anywhere large amounts of heat must be removed from a surface. The invention has great utility in the area of end-pumped diode-pumped alkali lasers where the pump light must be ducted down the gain region.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 is a schematic drawing showing the relationship between the sapphire mounted waveguide and the heat exchanger.

FIG. 2 is a scanning electron micrograph of micro-channels etched in silicon.

FIG. 3 is a side view drawing of an embodiment of the present improved waveguide structure.

FIG. 4 shows a perspective view of an embodiment of the invention.

FIG. 5 shows a plenum as it would be etched into the glass mounting block.

FIG. 6 is a perspective end view drawing of a DPAL cell incorporating an embodiment of the present invention.

FIG. 7 shows one T structure design for use with the embodiment of FIG. 6.

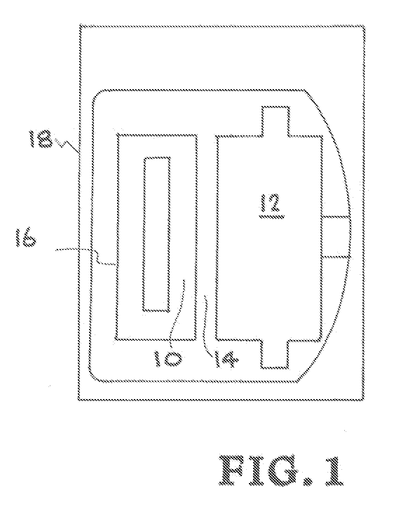

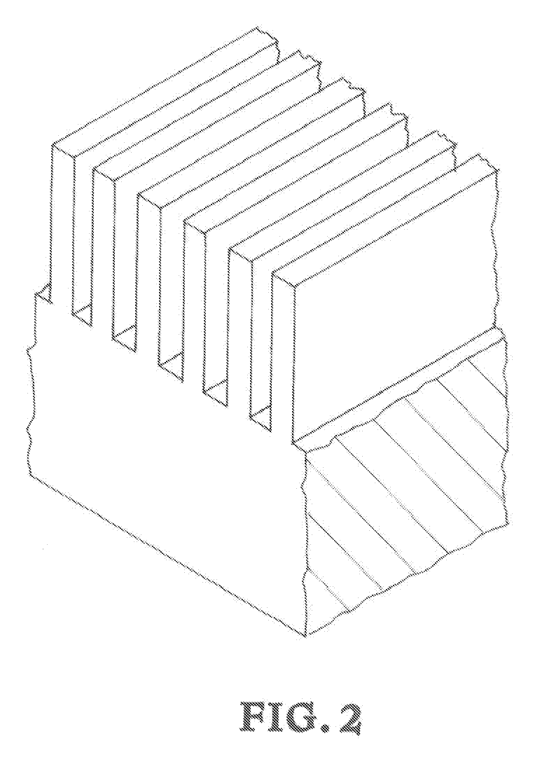

### DETAILED DESCRIPTION OF THE INVENTION

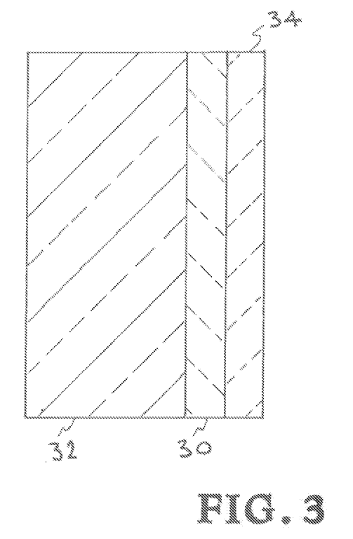

To overcome the limitations of the current heat exchanger design, a new design for the waveguides, as exemplified in FIG. 3. In this design, heat removal is done right at the waveguide, thus eliminating the need for a separate, bulky, heat exchanger. The dielectric stack serves the same purpose as before, to provide high reflectance at the pump wavelength and lower reflectance at the laser wavelength. Because the heat is removed right at the source, the temperature of the waveguide can be much better controlled. As a result, the waveguide temperature can closely match the temperature of the bulk gas flowing down the channel. This will result in greatly improved beam quality, as the steep temperature gradients near the waveguide have been eliminated.

Another feature of the proposed design lies in its simplicity, leading to greatly reduced weight. The extremely low thermal resistance of the waveguide system allows one to handle significantly greater amounts of fluorescence than is now possible. A consequence of this is the ability to increase the concentration of the laser-active species, and thus shorten the overall length of the gain medium. As a result, one achieves a more compact system. In terms of manufacturability, Si wafers with diameters of 300 mm are routinely available, and there is the possibility of going to 450 mm diameter in the near future. Such large sizes can easily accommodate several waveguides.

FIG. 3 is side view of an embodiment of an improved waveguide structure according to the present invention. The silicon micro-channel structure 30 will be described in more detail below. The structure is anodically bonded to glass manifold 32. Multi-layer dielectric stack 34 adheres to the silicon micro-channel structure 30. The multi-layer dielectric stack provides high reflectivity at the pump wavelength (780 nm) and lower reflectivity at the laser wavelength (795 nm). The thickness of the Si in one embodiment is within a range from approximately 1 mm.

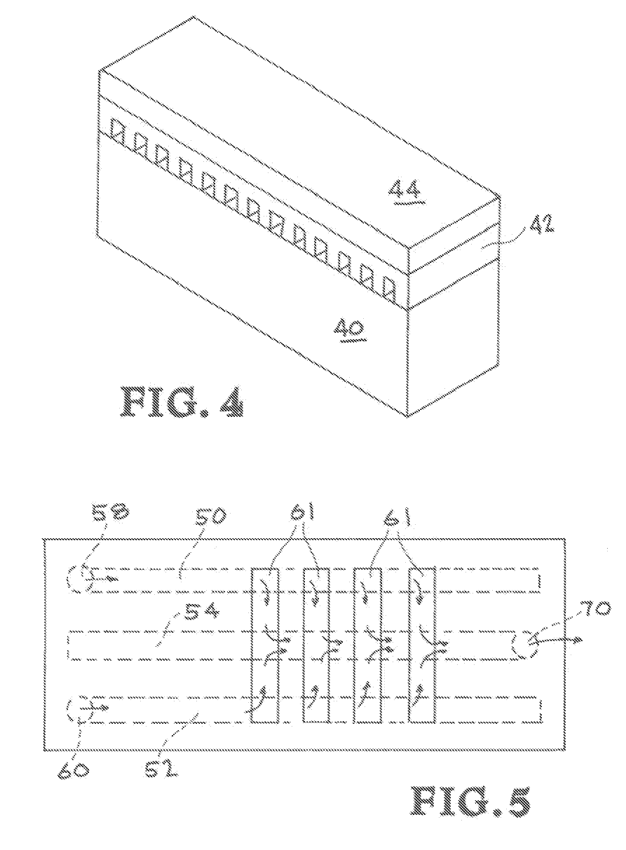

FIG. 4 shows a perspective view of an embodiment of the invention. It includes a glass mounting block 40, a silicon micro-channel structure 42 and a multilayer dielectric stack 44. The micro-channel is anodically bonded to the glass mounting block. The plenum of FIG. 5, as discussed below, is etched into the top of the glass mounting block. The silicon structure has micro-channels that are facing toward the glass mounting block. The range of thicknesses of the silicon capping layer between the micro-channels and the multilayer dielectric stack is about 20 μm to 500 μm. Each micro-channel has a width that ranges from 20 microns to 1 mm and a channel depth that ranges from 10 microns to 1 mm. The total thickness of the silicon micro-channel structure can be up to 1.2 mm.

FIG. 5 shows a top view of the glass mounting block with etched plenums. This embodiment is suitable far the embodiment of FIG. 4. There are two cooling fluid inlet plenums (50,52) and one cooling fluid outlet plenum 54. Representative micro-channels 56 are shown above the plenums. Cooling fluid enters plenums 50 and 52 at inlet ports 58 and 60 respectively. When the fluid reaches one of the micro-channels 61, a portion of the fluid flows through the micro-channel and into plenum 54 to exit the output port 70. Some of the cooling fluid continues to flow in the plenums 50 and 52 so that the fluid flows through other micro-channels and out of the system. As the fluid flows through the micro-channels, it comes into contact with the ˜1 mm portion of the silicon structure that is between the micro-channels and the multilayer dielectric stack. Note that other plenum structures are possible. For example, there may be only one inlet and one outlet. When there is more than one inlet plenum, each one may have the cooling fluid flowing in a direction that is opposite to the other plenum. Based on this disclosure, those skilled in the art will understand that other configurations are possible.

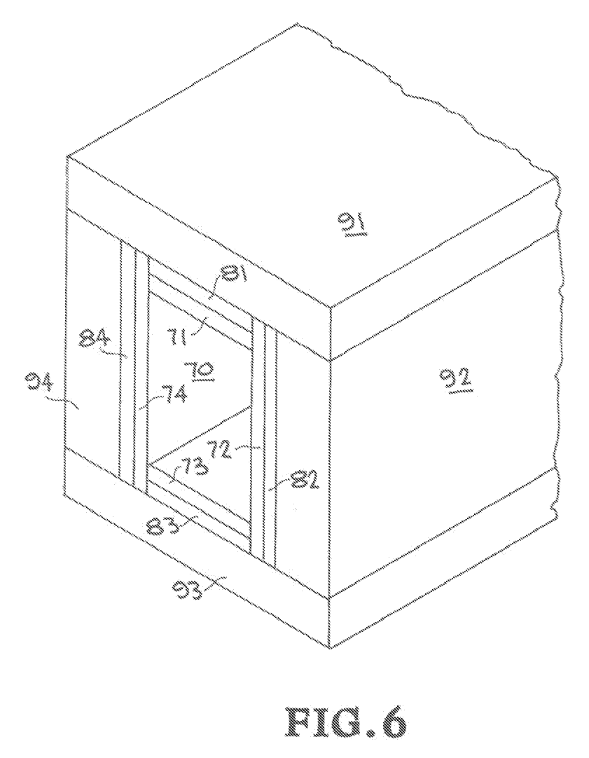

FIG. 6 is a perspective end view drawing of a portion of a DPAL cell incorporating an embodiment of the present invention. The cell includes a window 70 through which pump light enters the cell. Four multilayer dielectric stacks 71-74 form the inner walls of the cell. Each stack of the four multilayer dielectric stacks 71- 74 are in contact with a respective silicon micro-channel structure 81-84. As in the embodiments of FIGS. 3 and 4, the micro-channels are faced away from the multilayer dielectric stacks and do face their respective glass mounting block 91-94, each of which has a plenum structure etched on the surface of the glass mounting block that faces the micro-channel structure. The silicon structure is anodically bonded to the glass mounting block. Notice in the figure that stacks 74 and 72 and their associated silicon micro-structures extend the full length of their respective glass mounting blocks such that one of their ends is in contact with the upper block 91 and the other end is in contact with lower block 93. In this configuration, stacks 71 and 73 and their respective silicon micro-structures fit between stack 74 and stack 72. Other configurations are within the scope of this invention.

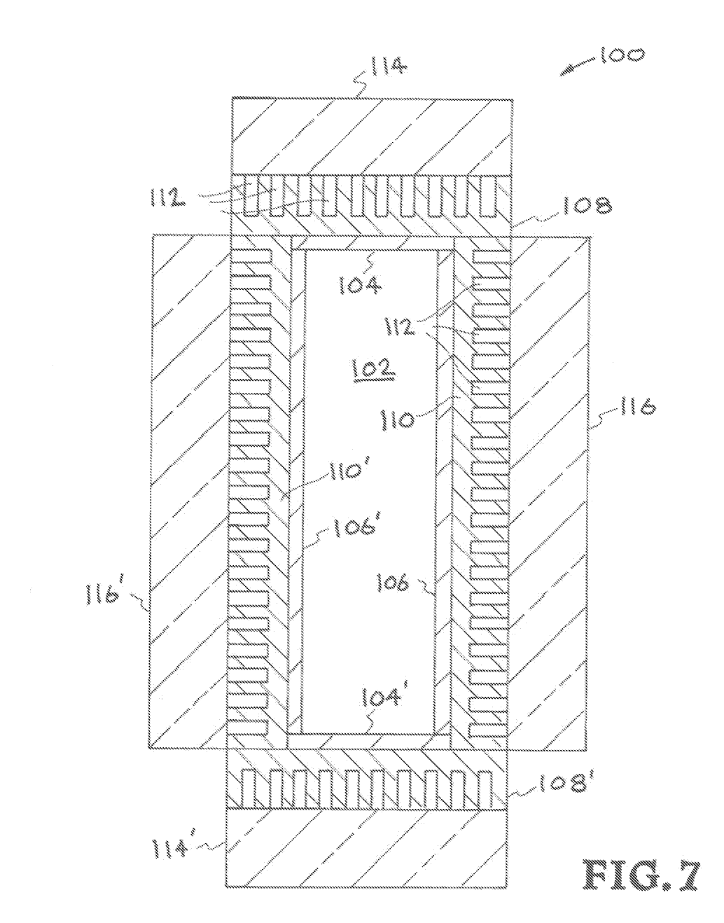

FIG. 7 is an end view drawing of a DPAL cell 100 incorporating an embodiment of the present invention. The figure shows a window 102, and four multilayer stacks 104, 104′, 106 and 106′ where each stack is in contact with its own silicon micro-structure 108, 108′, 110 and 110′ respectively which are anodically bonded to a respective glass mounting block 114, 114′, 116 and 116′. The silicon micro-structures include a thin layer of material that is in contact with the multilayer dielectric stack and also includes etched micro-channels as described in the previous embodiments. See, e.g., micro-channels 112. As discussed above, each glass mounting block includes plenums to provide a flow of cooling liquid through the micro-channels and to remove the cooling liquid after it has passed through the micro-channels. In this figure, the micro-channels run in a direction that is perpendicular to the plane of the page. In this configuration, the plenums are formed so that the cooling liquid flows through the plenums in a direction that is parallel to the plane of the page. This is but one example. The direction of the micro-channels and the plenums can be reversed as well. Other configurations will be apparent to those skilled in the art based on this disclosure.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
a mounting block comprising a first surface having a cooling liquid inlet plenum and a first cooling liquid outlet plenum;
a silicon micro-channel structure comprising a first major side and a second major side, wherein said first major side is substantially flat and wherein said second major side comprises micro-channels, wherein said second major side is bonded to said first surface of said glass mounting block; and
a structure to be cooled in contact with said first major side of said silicon micro-channel structure.

2. The apparatus of claim 1, wherein said mounting block comprises material selected from the group consisting of glass and silicon.

3. The apparatus of claim 1, wherein said mounting block comprises at least one additional cooling liquid inlet plenum.

4. The apparatus of claim 1, wherein said mounting block comprises at least one additional cooling liquid outlet plenum.

5. The apparatus of claim 1, wherein said mounting block comprises at least one additional cooling liquid inlet plenum and at least one additional cooling liquid outlet plenum.

6. The apparatus of claim 1, wherein said micro-channels are substantially parallel one to another.

7. The apparatus of claim 1, wherein each micro-channel has a width within a range from 20 microns to 1 mm and a channel depth that ranges from 10 microns to 1 mm, wherein the total thickness of said silicon micro-channel structure can be up to 1.2 mm.

8. The apparatus of claim 1, wherein said second major side is anodically bonded to said first surface of said glass mounting block.

9. The apparatus of claim 1, wherein said structure to be cooled is a reflector.

10. The apparatus of claim 1, wherein said structure to be cooled is a multi-layer dielectric stack.

11. The apparatus of claim 1, wherein said micro-channels have been etched into said silicon micro-channel structure.

12. The apparatus of claim 1, wherein said first cooling liquid inlet plenum and said first cooling liquid outlet plenum have been etched into said mounting block.

13. The apparatus of claim 1, wherein said multi-layer dielectric stack provides relatively high reflectivity at a first wavelength and relatively low reflectivity at a second wavelength.

14. The apparatus of claim 13, wherein said first wavelength is 780 nm and wherein said second wavelength is 795 nm.

15. The apparatus of claim 1, wherein the thickness of said silicon micro-channel structure between said micro-channels and said structure to be cooled is within a range from 20 μm to 500 μm.

16. The apparatus of claim 1, wherein said mounting block, said silicon micro-channel structure and said structure to be cooled form a first configuration, wherein said apparatus further comprises additional configurations identical to said first configuration, wherein said first configuration and said additional configurations together form a cavity, wherein each structure to be cooled of said first configuration and said additional configurations is configured to be the inner wall of said cavity, wherein said apparatus further comprises a first window located at a first end of said cavity and a second window located at a second end of said cavity.

17. The apparatus of claim 16, further comprises means for providing a laser gain medium within said cavity.

18. The apparatus of claim 16, further comprises means for providing alkali vapor laser gain medium within said cavity.

19. The apparatus of claim 16, further comprising a laser gain medium within said cavity.

20. The apparatus of claim 16, further comprising an alkali vapor laser gain medium within said cavity.

21. The apparatus of claim 19, further comprising means for optically pumping said laser gain medium.

22 The apparatus of claim 21, wherein said means for optically pumping said laser gain medium comprises a plurality of laser diodes.

23. A method, comprising:
providing an apparatus, comprising:
a mounting block comprising a first surface having a first cooling liquid inlet plenum and a first cooling liquid outlet plenum;
a silicon micro-channel structure comprising a first major side and a second major side, wherein said first major side is substantially flat and wherein said second major side comprises micro-channels, wherein said second major side is bonded to said first surface of said glass mounting block;
a reflector to be cooled in contact with said first major side of said silicon micro-channel structure, wherein said mounting block, said silicon micro-channel structure and said reflector to be cooled form a first configuration;
additional configurations identical to said first configuration, wherein said first configuration and said additional configurations together form a cavity, wherein each reflector to be cooled of said first configuration and said additional configurations is configured to be the inner wall of said cavity, wherein said apparatus further comprises a first window located at a first end of said cavity and a second window located at a second end of said cavity; and
a laser gain medium within said cavity,
the method further comprising optically pumping said gain medium.

24. The method of claim 23, wherein said laser gain medium comprises an alkali vapor.

25. The method of claim 23, wherein said mounting block comprises material selected from the group consisting of glass and silicon.

26. The method of claim 23, wherein each micro-channel has a width, within a range from 20 microns to 1 mm and a channel depth that ranges from 10 microns to 1 mm, wherein the total thickness of said silicon micro-channel structure can be up to 1.2 mm.

27. The method of claim 23, wherein said reflector to be cooled is a multi-layer dielectric stack.

28. The method of claim 27, wherein said multi-layer dielectric stack provides relatively high reflectivity at a first wavelength and relatively low reflectivity at a second wavelength, wherein said first wavelength is 780 nm and wherein said second wavelength is 795 nm.

29. The method of claim 23, wherein the thickness of said silicon micro-channel structure between said micro-channels and said structure to be cooled is within a range from 20 μm to 500 μm.

30. The method of claim 23, wherein the step of optically pumping said gain medium is carried out with a plurality of laser diodes.
